(19) United States
(12) Patent Application Publication
(10) Pub. No.: US 2025/0136061 A1
(43) Pub. Date: May 1, 2025

(54) starting power source for car battery

(71) Applicant: Yuyao Yiheng Automotive Supplies Co., Ltd., Yuyao City (CN)

(72) Inventor: Long Cheng, Yuyao City (CN)

(73) Assignee: Yuyao Yiheng Automotive Supplies Co., Ltd., Yuyao City (CN)

(21) Appl. No.: 18/796,661

(22) Filed: Aug. 7, 2024

(30) Foreign Application Priority Data
Oct. 26, 2023 (CN) 202311413243.3

(51) Int. Cl. B60S 3/00; A47L 5/14; A47L 5/24; A47L 7/00; A47L 9/12; A47L 9/14; A47L 9/22; A47L 9/30; B60S 5/04; H01M 50/202; H01M 50/247; H01M 50/271; H01M 50/296

(52) U.S. Cl. CPC B60S 3/008; A47L 5/14; A47L 5/24; A47L 7/0076; A47L 7/0085; A47L 9/127; A47L 9/1418; A47L 9/1427; A47L 9/22; A47L 9/30; B60S 5/04; H01M 50/202; H01M 50/247; H01M 50/271; H01M 50/296; H01M 2220/20; H01M 2220/30

(57) ABSTRACT

The present application relates to a starting power supply for car battery, belonging to the technical field of car accessories, comprising a housing, a power module installed inside the housing to charge the car battery, an inflation module for inflation, and a vacuumizing module for vacuumization, wherein the housing is provided with a lighting lamp that is electrically connected to the power module, and the power module is adjacent to and is spaced apart from the inflation module, and the vacuumizing module is located at the bottom of the power module. The present application has the effect of increasing the functionality of emergency power supply.

### REFERENCE TO PRIOR APPLICATION

This application claims priority to Chinese Patent Application 202311413243.3, filed on Oct. 26, 2023, which is incorporated herein by reference.

### TECHNICAL FIELD

This application relates to the field of automobile accessory technology, particularly to a starting power supply for car batteries.

### BACKGROUND

With the improvement of people's living standards, almost every household will have a car as a means of transportation. The internal circuits of the car are powered by the car battery which will continue to provide power when the car is powered off but the lights or other circuits on the car are not, leading to insufficient or depleted battery power that cannot start a car. Therefore, most cars are equipped with an emergency power source that can charge the car battery.

When driving to camp, you may face various unexpected situations. In related technologies, emergency power supply has such a single function that it can only be used as a power source.

### SUMMARY OF INVENTION

In order to increase the functionality of emergency power supply, the present application provides a starting power supply for car battery.

The present application provides a starting power supply for car battery, based on the following technical solutions:

A starting power supply for car battery, comprising a housing, a power module installed inside the housing to charge the car battery, an inflation module for inflation, and a vacuumizing module for vacuumization, wherein the housing is provided with a lighting lamp that is electrically connected to the power module, and the power module is adjacent to and is spaced apart from the inflation module, and the vacuumizing module is located at the bottom of the power module.

Alternatively, the power module comprises a lithium battery block and a multifunctional wiring port, and the multifunctional wiring port comprises a car battery wiring port, a fast charging wiring port, and a data cable wiring port.

Alternatively, the inflation module comprises an inflation pump and an inflation head, the inflation pump is installed inside the housing, the inflation head is installed on the inflation pump, and the housing is provided with an inflation port for the inflation head to insert and pass through.

Alternatively, the housing comprises an liner, an outer shell sleeve, and a heat dissipation top cover, and the power module and the inflation module are both disposed inside the liner, the outer shell sleeve is sleeved on the liner, a heat dissipation gap is provided between the outer shell sleeve and the liner, the liner is provided with an inner heat dissipation through-hole connected to the heat dissipation gap, and the outer wall of the outer shell sleeve is provided with an outer shell heat dissipation through-hole connected to the heat dissipation gap, the heat dissipation top cover is disposed on the top of the liner, and the heat dissipation top cover is provided with a top cover heat dissipation through-hole for dissipating the internal heat of the liner.

Alternatively, the liner comprises a first inner shell and a second inner shell, an installation chamber is provided on one side of the first inner shell close to the second inner shell, and the bottom of installation chamber is provided with a plurality of partitions that are spliced to form a battery placement slot to accommodate the lithium battery block, and the bottom of installation chamber is also provided with a limit slot, and the inflation pump is provided with a limit block that is inserted into the slot to limit the inflation pump, and the internal heat dissipation through-hole is disposed on the first inner shell.

Alternatively, the vacuumizing module is a vacuum cleaner module comprising a dust collecting bucket, a vacuum motor, a filter ring, and a ring protection support, the top of the dust collecting bucket is open, the dust collecting bucket is nap-fitted at the bottom of the liner, the vacuum motor is installed inside the liner, and the filter ring is installed at the bottom of the liner and inserted into the dust collecting bucket, the ring protection bracket is installed at the bottom of the liner and fitted onto the filter ring, the side wall of the dust collecting bucket is provided with a suction port that is connected to the interior of dust collecting bucket and fits the vacuum nozzles of different specifications or vacuum suction nozzles.

Alternatively, a convex ring is provided at the bottom of the liner, the outer peripheral wall of the convex ring is provided with a limit block, the ring protection bracket is sleeved on the convex ring, and the inner wall of the ring protection bracket is provided with an L locking groove in which the limit block slides, inserts, and rotates to limit the ring protection bracket on the convex ring;

a top opening dust bag is provided inside the dust collecting bucket, and a dust inlet connected to the suction port is provided on one side of the dust bag near the suction port to allow in garbage, and an elastic annule is provided at the dust inlet to tighten the dust inlet, and an expansion ring is provided at the suction port to fit the elastic annule to make the dust inlet (551) open.

Alternatively, the expansion ring, a conical ring, extends towards the direction close to the ring protection bracket, the outer diameter of the expansion ring on the side close to the ring protection bracket is smaller than the outer diameter on the side away from the ring protection bracket, and a groove is provided on the outer wall of the expansion ring on the side away from the liner for the partial insertion of the elastic annule;
a notch is provided on one side of the expansion ring near the liner, and a limit rocker plate is rotatably installed at the notch, the side wall of the limit rocker plate is provided with a rotating shaft through which the limit rocker plate is rotatably installed on the mouth wall at the notch, the distance from the side of the limit rocker plate near the ring protection bracket to the rotating shaft is greater than the distance from the side of the limit rocker plate away from the ring protection bracket to the rotating shaft, and the bottom of liner is provided with a driving rod that drives the limit rocker to rotate, so that the elastic annule is less likely to detach from the expansion ring, and the limit rocker is provided with a caulking groove for partial insertion of the elastic annule;
when the dust collecting bucket is snap-fitted on the liner, the driving rod drives the limit rocker to rotate and limit the elastic annule to the expansion ring;
when the dust collecting bucket is removed from the liner, the limit rocker automatically rotates and resets to detach elastic annule from the caulking groove and make the dust inlet in a closed state.

Alternatively, the outer peripheral wall of the dust bag is provided with a plurality of dovetail strips spaced apart in the circumferential direction, and the inner peripheral wall of the dust collecting bucket is provided with a plurality of dovetail grooves in which the dovetail strips slides and inserts to limit the dust bag;
the opening of the dust bag is provided with a contraction rope to shrink the opening, and the ring protection bracket is provided with a hook to hang the contraction rope;
when the dust collecting bucket is removed from the liner, the dust bag moves together with the dust collecting bucket, and meanwhile the contraction rope helps contract the opening of dust bag.

Alternatively, the vacuumizing module is a blower that is installed inside the liner, and the bottom of the housing is provided with an air inlet into which vacuum suction nozzles can be inserted, and an air outlet into which blowing nozzles of different specifications can be inserted.

In summary, this application includes at least one beneficial technical effect as follows:
1. For camping outdoors, the starting power source can not only be used as an emergency power source for the car battery, but also as a lighting lamp, the inflation module can inflate car tires or air mattress for camping and, when the vacuumizing module is a vacuum cleaner module, in addition to vacuuming and cleaning the interior of the car, the vacuumizing module can also vacuum the food placed in the vacuum bag through the vacuum port, extracting most of the air in the vacuum bag, providing more versatile functions suitable for different occasions;
2. When the vacuumizing module is a blower, the air blown out from the air outlet of blower during camping can help with combustion and make a fire outdoors and, in addition, the vacuum suction nozzle that is inserted into air inlet of blower can evacuate air in the vacuum bag, allowing for vacuum preservation of food in the vacuum bag;
3. During the removal of garbage inside the dust collecting bucket, the driving rod will no longer drive limit rocker to limit the elastic annule and, as the rotation axis of limit rocker is not at the center position, the limit rocker, after losing the limit of the driving rod, will automatically rotate and reset and, at the same time because the expansion ring is a conical ring, the elastic annule will, after losing the limit of the limit rocker, automatically detach from the expansion ring and gather together, so that the dust inlet contracts to prevent the escape of dust or garbage in the dust bag herefrom;
4. When removing the garbage inside the dust collecting bucket, the dust bag moves together with the dust collecting bucket and, due to the contraction rope hanging on the hook, the opening of the dust bag will also contract together under the action of contraction rope, and the filter ring will be wrapped in the dust bag, and then user may tap the filter ring to make the attachments on the filter ring fall into the dust bag, and finally remove the contraction rope from the hook, cleaning the garbage in the dust collecting bucket more conveniently.

### BRIEF DESCRIPTION OF THE DRAWINGS

FIG. 1 is a schematic diagram of the overall structure of the starting power supply in Embodiment 1 of the present application.

FIG. 2 is an exploded view of the starting power supply in Embodiment 1 of the present application.

FIG. 3 is an exploded view of the shell sleeve in Embodiment 1 of the present application.

FIG. 4 is a schematic diagram of the installation structure of the power module and inflation module in Embodiment 1 of the present application.

FIG. 5 is a 3D sectional view of the starting power supply in Embodiment 1 of the present application.

FIG. 6 is an exploded view of the vacuum cleaner module in Embodiment 1 of the present application.

FIG. 7 is a schematic diagram of the installation structure of ring protection bracket in Embodiment 1 of the present application.

FIG. 8 is an enlarged partial sectional view of Embodiment 1 of the present application.

FIG. 9 is an exploded view of the starting power supply in Embodiment 2 of the present application.

FIG. 10 is a bottom 3D view of the starting power supply in Embodiment 2 of the present application.

Annotations on accompanying drawings: 1. Shell; 11. Liner; 111. Internal heat dissipation through-hole; 112. First inner shell; 113. Second inner shell; 114. Installation chamber; 115. Partition; 116. Battery placement slot; 117. Limit slot; 12. Shell sleeve; 121. Outer shell heat dissipation through-hole; 13. Heat dissipation top cover; 131. Top cover heat dissipation through-hole; 132. Lighting lamp; 133. Inflation port; 14. Handle; 15. Monitor; 16. Operation button; 17. Ventilation hole; 18. Convex ring; 181. Limit block; 2. Power module; 21. Lithium battery block; 22. Multifunctional wiring port; 221. Car battery wiring port; 222. Fast charging wiring port; 223. Data cable wiring port; 3. Inflation module; 31. Inflation pump; 311. Limit block; 32. Inflation head; 4. Vacuumizing module; 5. Vacuum cleaner module; 51. Dust collecting bucket; 511. Vacuum suction port; 512. Dovetail groove; 513. Expansion ring; 514. Groove; 515. Notch; 52. Vacuum motor; 53. Filter ring; 54. Ring protection bracket; 541, L locking slot; 542. Hook; 55. Dust bag; 551. Dust inlet; 552, Dovetail strip; 553. Elastic annule; 554. Contraction rope; 56. Limit rocker; 561. Caulking groove; 57. Driving rod; 6. Blower; 61. Air inlet; 62. Air outlet.

### DETAILED DESCRIPTION OF THE EMBODIMENTS

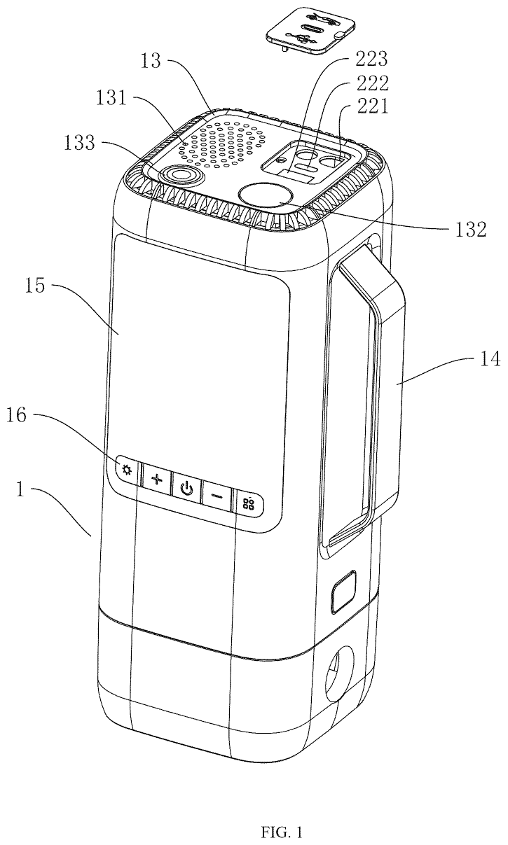

Further detailed explanation of the present application is provided in conjunction with FIG. 1-10.

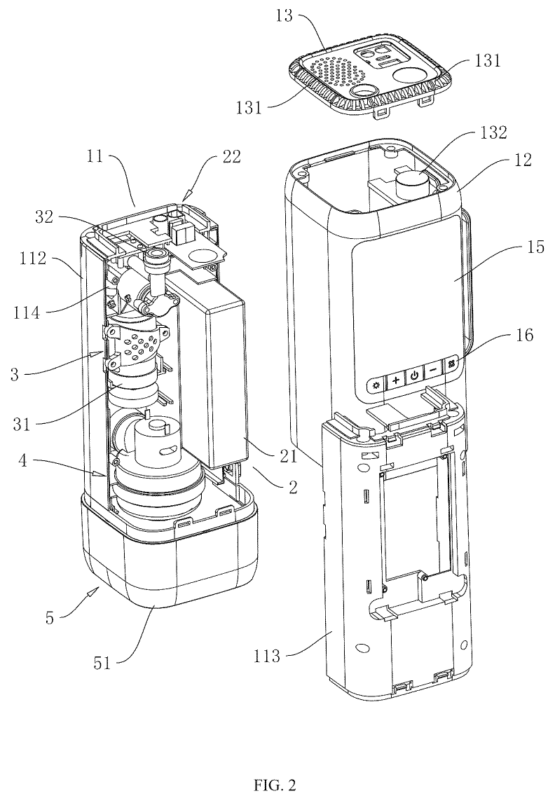

The present embodiment discloses a starting power supply for car battery. Referring to FIG. 1 and FIG. 2, the starting power supply for car battery comprises a housing 1, a power module 2, an inflation module 3, and a vacuumizing module 4, wherein the inflation module 3 and vacuumizing module 4 are both electrically connected to the power module 2, and the power module 2, inflation module 3, and vacuumizing module 4 are all installed inside the housing 1, the power module 2 is adjacent to the inflation module 3 at intervals, and the vacuumizing module 4 is located at the bottom of power module 2. Power module 2 can charge car batteries or electronic devices, while inflation module 3 can charge car tires or inflatable mattress during camping. The vacuumizing module 4 can vacuum the food or fruits in the vacuum bag during camping.

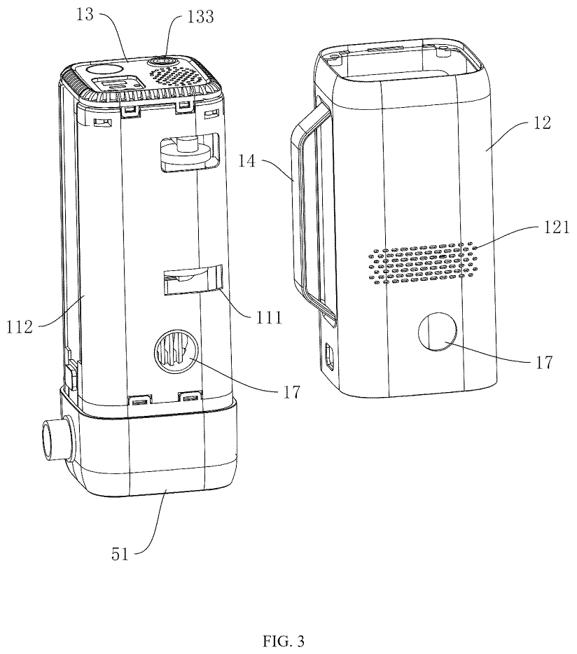

Based on FIG. 1, and referring to FIGS. 2 and 3, Embodiment 1: the housing 1 comprises an liner 11, an outer shell sleeve 12, a heat dissipation top cover 13 and a handle. The power module 2 and inflation module 3 are both disposed inside the liner 11, the outer shell sleeve 12 is sleeved on the liner 11, and the heat dissipation top cover 13 is disposed on the top of the liner 11 for dissipating the internal heat of the liner 11. The handle 14 is fixedly installed on the shell sleeve 12 for easy lifting and movement of the entire starting power supply.

A heat dissipation gap is provided between the outer shell sleeve 12 and the liner 11, the liner 11 is provided with an inner heat dissipation through-hole 111 connected to the heat dissipation gap, and the outer wall of the outer shell sleeve 12 is provided with an outer shell heat dissipation through-hole connected to the heat dissipation gap 121, and the heat dissipation top cover (13) is provided with a top cover heat dissipation through-hole 131 for dissipating the internal heat of the liner 11. The outer shell sleeve 12 is provided with a display 15 and an operation button 16. The air pressure of inflation module 3 can be controlled through the operation button 16, and some data on the inflation module 3 will be displayed through the display 15.

Based on FIG. 1, and referring to FIGS. 2 and 3, the liner 11 comprises a first inner shell 112 and a second inner shell 113, an installation chamber 114 is provided on one side of the first inner shell 112 close to the second inner shell 113. The power module 2 and inflation module 3 are both installed in the installation chamber 114, and the internal heat dissipation through-hole 111 is disposed on the first inner shell 112 and connected to the installation chamber 114. The first inner shell 112 and the second inner shell 113 are fixed together by bolts.

A lighting lamp 132 is installed on the heat dissipation top cover 13 and is electrically connected to the power module 2.

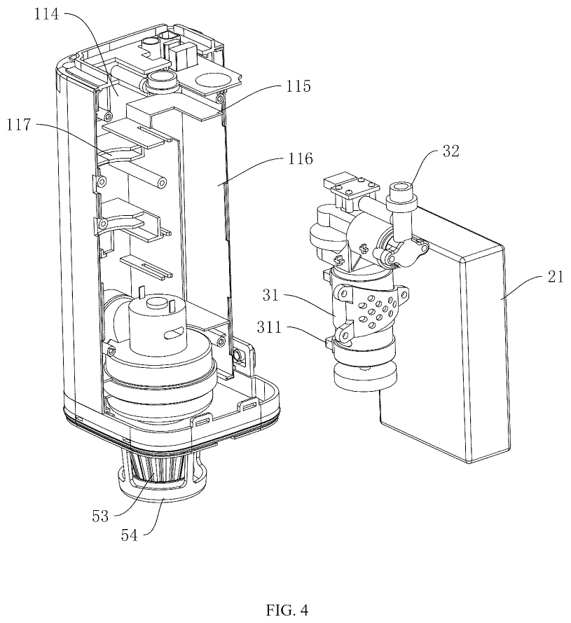

Based on FIG. 2, and referring to FIGS. 3 and 4, the power module 2 comprises a lithium battery block 21, and a multifunctional wiring port 22 that is electrically connected to lithium battery block 21, and the multifunctional wiring port 22 comprises a car battery wiring port 221, a fast charging wiring port 222, and a data cable wiring port 223. The bottom of installation chamber 114 is provided with a plurality of partitions 115 that are spliced to form a battery placement slot 116 to accommodate the lithium battery block 21, and the lithium battery block 21 is partially inserted into the battery placement slot 116 and partially located inside the second inner shell 113.

The inflation module 3 comprises an inflation pump 31 and an inflation head 32. The inflation pump 31 is installed inside the installation chamber 114, the inflation head 32 is installed on the inflation pump 31, and the top of heat dissipation cover 13 is provided with an inflation port 133 for the inflation head 32 to insert and pass through. The bottom of the installation chamber 114 is also provided with a limit slot 117, and the inflation pump 31 is provided with a limit block 311 that is inserted into the limit slot 117 to limit the inflation pump 31. After the limit block 311 is inserted into the limit slot 117, the inflation pump 31 is fixed to the first inner shell 112 by bolts.

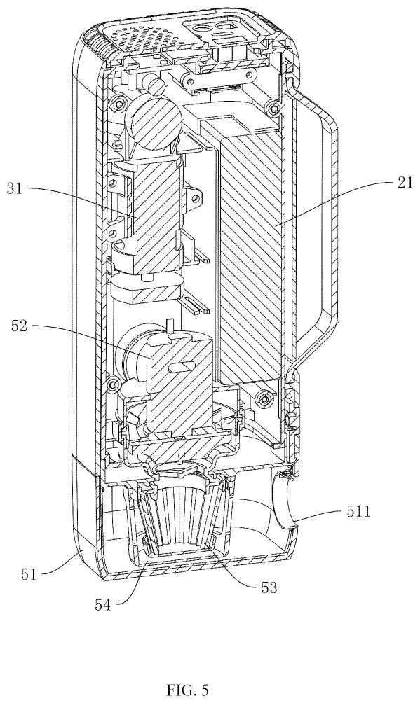

Based on FIG. 3, and referring to FIGS. 4 and 5, vacuumizing module 4 is vacuum cleaner module 5, comprising a dust collecting bucket 51, a vacuum motor 52, a filter ring 53, and a ring protection bracket 54, and the top opening dust collecting bucket 51 is snap-fitted at the bottom of the liner 11. The vacuum motor 52 is installed inside the liner 11, and a bottom plate is provided at the bottom of liner 11, and the bottom plate has a ventilation opening that connects the interior of the liner 11 with the interior of the dust collecting bucket 51. The first inner shell 112 and the outer shell sleeve 12 are both provided with ventilation holes 17 for the vacuum motor 52 to communicate with the external air. The filter ring 53 is installed at the bottom of the liner 11 and inserted into the dust collecting bucket 51, the ring protection bracket 54 is installed at the bottom of the liner 11 and is fitted onto the filter ring 53 for protection, and the side wall of the dust collecting bucket 51 is provided with a suction port 511 that is connected to the interior of the dust collecting bucket 51. Vacuum nozzle of different specifications can be inserted into the vacuum port 511, and vacuum nozzle for vacuuming purpose can also be inserted into the vacuum port 511. When vacuuming is required, the vacuum nozzle can be inserted into the vacuum bag and the vacuum motor 52 can be started.

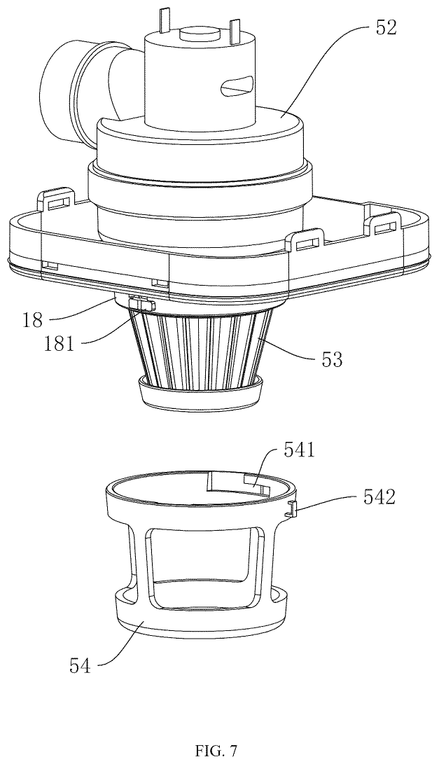

Based on FIG. 5, and referring to FIGS. 64 and 7, a convex ring (18) is provided at the bottom of the liner (11), the outer peripheral wall of the convex ring (18) is provided with a limit block (181), the ring protection bracket (54) is sleeved on the convex ring (18), and the inner wall of the ring protection bracket (54) is provided with an L locking groove (541) in which the limit block (181) slides, inserts, and rotates to limit the ring protection bracket (54) on the convex ring (18); When installing the ring protection bracket 54, first insert the limit block 181 into the vertical groove of L locking groove 541, then push the ring protection bracket 54 to move, and finally rotate the ring protection bracket 54 so that the limit block 181 is located in the horizontal groove of L locking groove 541, making the disassembly of ring protection bracket 54 more convenient.

A top opening dust bag 55 is provided inside the dust collecting bucket 51, and a dust inlet 551 connected to the suction port 511 is provided on one side of the dust bag 55 near the suction port 511 to allow in garbage. The outer peripheral wall of the dust bag 55 is provided with a plurality of dovetail strips 552 spaced apart in the circumferential direction, and the inner peripheral wall of the dust collecting bucket 51 is provided with a plurality of dovetail grooves 512 in which the dovetail strips 552 slides and inserts to limit the dust bag 55. Furthermore, when the vacuum motor 52 rotates, the dust bag 55, because of the fit between the dovetail strip 552 and the dovetail groove 512, is less likely to move towards the filter ring 53 due to the suction force.

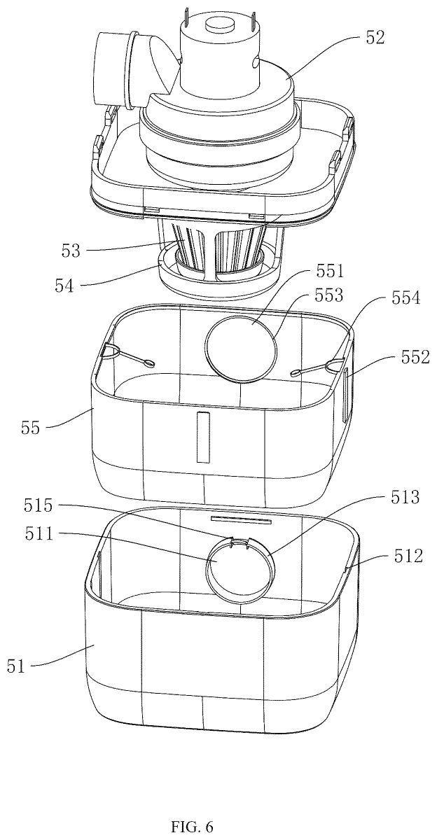

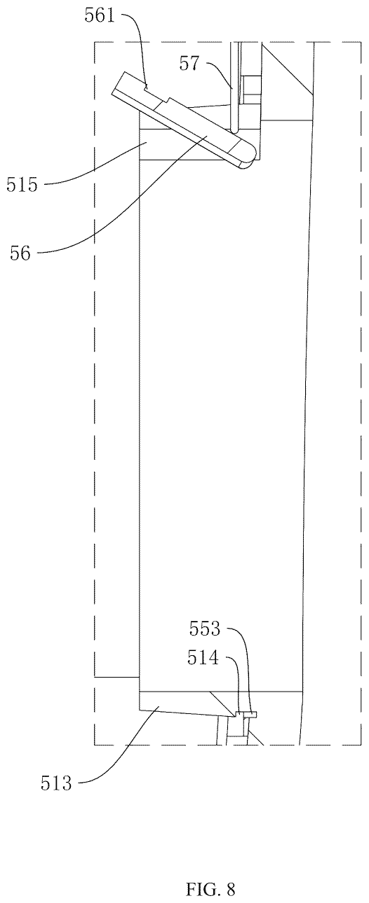

Based on FIG. 6, and referring to FIGS. 7 and 8, an elastic annule 553 is provided at the dust inlet 551 to tighten the dust inlet 551, and an expansion ring 513 is provided at the suction port 511 to fit the elastic annule 553 to make the dust inlet 551 open. The expansion ring 513 extends towards the direction close to the ring protection bracket 54, and the expansion ring 513 is a conical ring, and the outer diameter of the expansion ring 513 on the side close to the ring protection bracket 54 is smaller than that on the side far away from the ring protection bracket 54.

A groove 514 for the partial insertion of elastic annule 553 is provided on the outer wall of the expansion ring 513 on the side away from the liner 11, a notch 515 is provided on the side of the expansion ring 513 near the liner 11, and a limit rocker 56 is rotatably installed at the notch 515, and a rotating shaft is provided on the side wall of the limit rocker 56, and the limit rocker 56 is rotatably installed on the wall of the notch 515 through the rotating shaft; the distance from the side of the limit rocker 56 near the ring protection bracket 54 to the rotating shaft is greater than the distance from the side of the limit rocker 56 away from the ring protection bracket 54 to the rotating shaft; a driving rod 57 is provided at the bottom of liner 11 to drive the limit rocker 56 to rotate so that the elastic ring 553 is less likely to detach from the expansion ring 513, and a caulking groove 561 is provided on the limit rocker 56 for the partial insertion of the elastic annule 553.

Based on FIG. 6, and referring to FIGS. 7 and 8, when the dust collecting bucket 51 is snap-fitted on the liner 11, the driving rod 57 drives the limit rocker 56 to rotate and limit the elastic annule (553 to the expansion ring (513); when the dust collecting bucket 51 is removed from the liner 11, the limit rocker 56 automatically rotates and resets to detach elastic annule 553 from the caulking groove 561 and make the dust inlet 551 in a closed state.

The opening of the dust bag 55 is provided with a contraction rope 554 that can shrink the opening of the dust bag 55, and the ring protection bracket 54 is provided with two hooks 542 spaced apart in the circumferential direction for hanging the contraction rope 554. When the dust collecting bucket 51 is removed from the liner 11, the dust bag 55 moves together with the dust collecting bucket 51, and meanwhile the contraction rope 554 helps contract the opening of dust bag 55.

The implementation principle of a starting power supply for car battery in the present application is as follows: For camping outdoors, the starting power source can not only be used as an emergency power source for the car battery, but also as a lighting lamp 132, the inflation module 3 can inflate car tires or air mattress for camping and, when the vacuumizing module 4 is a vacuum cleaner module 5, in addition to vacuuming and cleaning the interior of the car, the vacuumizing module 5 can also vacuum the food placed in the vacuum bag through the vacuum port 511, extracting most of the air in the vacuum bag, providing more versatile functions suitable for different occasions;

During the removal of garbage inside the dust collecting bucket 51, the driving rod 57 will no longer drive limit rocker 56 to limit the elastic annule 553 and, as the rotation axis of limit rocker 56 is not at the center position, the limit rocker 56, after losing the limit of the driving rod 57, will automatically rotate and reset and, at the same time because the expansion ring 513 is a conical ring, the elastic annule 553 will, after losing the limit of the limit rocker 56, automatically detach from the expansion ring 513 and gather together, so that the dust inlet 551 contracts to prevent the escape of dust or garbage in the dust bag 55 from the dust inlet 551;

When removing the garbage inside the dust collecting bucket 51, the dust bag 55 moves together with the dust collecting bucket 51 and, due to the contraction rope 554 hanging on the hook 542, the opening of the dust bag 55 will also contract together under the action of contraction rope 554, and the filter ring 53 will be wrapped in the dust bag 55, and then user may tap the filter ring 53 to make the attachments on the filter ring 53 fall into the dust bag 55, and finally remove the contraction rope 554 from the hook 542, cleaning the garbage in the dust collecting bucket 51 more conveniently.

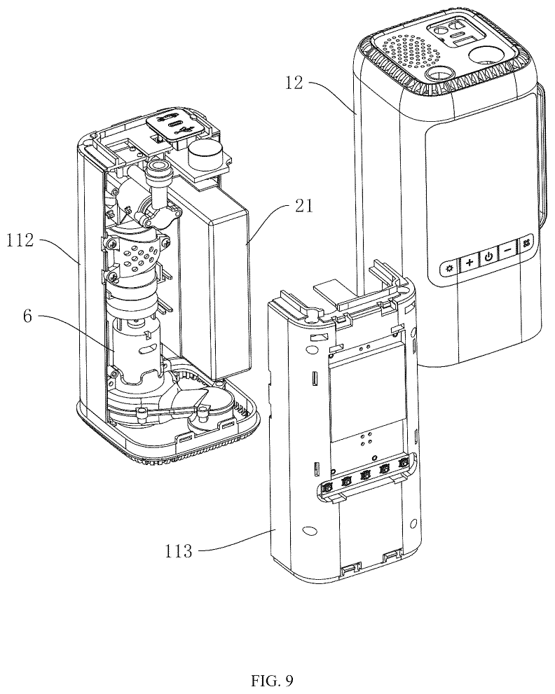

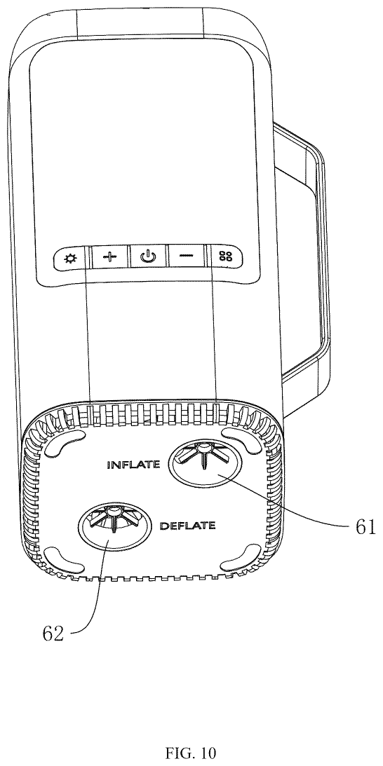

In Embodiment 2, referring to FIGS. 9 and 10, the difference between this embodiment and Embodiment 1 is that: the vacuumizing module 4 is a blower 6 that is installed inside the liner 11, and the bottom of the housing 1 is provided with an air inlet 61 into which vacuum suction nozzles can be inserted, and an air outlet 62 into which blowing nozzles of different specifications can be inserted. The air blown out from the air outlet 62 of blower 6 during camping can help with combustion and make a fire outdoors and, in addition, the vacuum suction nozzle that is inserted into air inlet 61 of blower 6 can evacuate air in the vacuum bag, allowing for vacuum preservation of food in the vacuum bag;

The above preferred embodiments of the present application do not limit the scope of protection hereof and therefore, the equivalent changes made according to the structure, shape, and principle hereof shall be included in the scope of protection hereof.

What is claimed is:

1. A starting power supply for car battery, comprising a housing (1), a power module (2) installed inside the housing (1) to charge the car battery, an inflation module (3) that is used for inflation, and a vacuumizing module (4) that is used for vacuumization, wherein the housing (1) is provided with a lighting lamp (132) that is electrically connected to the power module (2), and the power module (2) is adjacent to and is spaced apart from the inflation module (3), and the vacuumizing module (4) is located at the bottom of the power module (2).

2. The starting power supply for car battery according to claim 1, wherein the power module (2) comprises a lithium battery block (21) and a multifunctional wiring port (22), and the multifunctional wiring port (22) comprises a car battery wiring port (221), a fast charging wiring port (222), and a data cable wiring port (223).

3. The starting power supply for car battery according to claim 2, wherein the inflation module (3) comprises an inflation pump (31) and an inflation head (32), the inflation pump (31) is installed inside the housing (1), the inflation head (32) is installed on the inflation pump (31), and the housing (1) is provided with an inflation port (133) for the inflation head (32) to insert and pass through.

4. The starting power supply for car battery according to claim 3, wherein the housing (1) comprises an liner (11), an outer shell sleeve (12), and a heat dissipation top cover (13), the power module (2) and the inflation module (3) are both disposed inside the liner (11), the outer shell sleeve (12) is sleeved on the liner (11), a heat dissipation gap is provided between the outer shell sleeve (12) and the liner (11), the liner (11) is provided with an inner heat dissipation through-hole (111) connected to the heat dissipation gap, and the outer wall of the outer shell sleeve (12) is provided with an outer shell heat dissipation through-hole connected to the heat dissipation gap (121), the heat dissipation top cover (13) is disposed on the top of the liner (11), and the heat dissipation top cover (13) is provided with a top cover heat dissipation through-hole (131) for dissipating the internal heat of the liner (11).

5. The starting power supply for car battery according to claim 4, wherein the liner (11) comprises a first inner shell (112) and a second inner shell (113), an installation chamber (114) is provided on one side of the first inner shell (112) close to the second inner shell (113), and the bottom of installation chamber (114) is provided with a plurality of partitions (115) that are spliced to form a battery placement slot (116) to accommodate the lithium battery block (21), and the bottom of installation chamber (114) is also provided with a limit slot (117), and the inflation pump (31) is provided with a limit block (311) that is inserted into the the slot (117) to limit the inflation pump (31), and the internal heat dissipation through-hole (111) is disposed on the first inner shell (112).

6. The starting power supply for car battery according to claim 4, wherein the vacuumizing module (4) is a vacuum cleaner module (5) comprising a dust collecting bucket (51), a vacuum motor (52), a filter ring (53), and a ring protection support (54), the top of the dust collecting bucket (51) is open, the dust collecting bucket (51) is nap-fitted at the bottom of the liner (11), the vacuum motor (52) is installed inside the liner (11), and the filter ring (53) is installed at the bottom of the liner (11) and inserted into the dust collecting bucket (51), the ring protection bracket (54) is installed at the bottom of the liner (11) and fitted onto the filter ring (53), the side wall of the dust collecting bucket (51) is provided with a suction port (511) that is connected to the interior of dust collecting bucket (51) and fits the vacuum nozzles of different specifications or vacuum suction nozzles.

7. The starting power supply for car battery according to claim 6, wherein a convex ring (18) is provided at the bottom of the liner (11), the outer peripheral wall of the convex ring (18) is provided with a limit block (181), the ring protection bracket (54) is sleeved on the convex ring (18), and the inner wall of the ring protection bracket (54) is provided with an L locking groove (541) in which the limit block (181) slides, inserts, and rotates to limit the ring protection bracket (54) on the convex ring (18);
a top opening dust bag (55) is provided inside the dust collecting bucket (51), and a dust inlet (551) connected to the suction port (511) is provided on one side of the dust bag (55) near the suction port (511) to allow in garbage, and an elastic annule (553) is provided at the dust inlet (551) to tighten the dust inlet (551), and an expansion ring (513) is provided at the suction port (511) to fit the elastic annule (553) to make the dust inlet (551) open.

8. The starting power supply for car battery according to claim 7, wherein the expansion ring (513), a conical ring, extends towards the direction close to the ring protection bracket (54), the outer diameter of the expansion ring (513) on the side close to the ring protection bracket (54) is smaller than the outer diameter on the side away from the ring protection bracket (54), and a groove (514) is provided on the outer wall of the expansion ring (513) on the side away from the liner (11) for the partial insertion of the elastic annule (553);
a notch (515) is provided on one side of the expansion ring (513) near the liner (11), and a limit rocker plate (56) is rotatably installed at the notch (515), the side wall of the limit rocker plate (56) is provided with a rotating shaft through which the limit rocker plate (56) is rotatably installed on the mouth wall at the notch (515), the distance from the side of the limit rocker plate (56) near the ring protection bracket (54) to the rotating shaft is greater than the distance from the side of the limit rocker plate (56) away from the ring protection bracket (54) to the rotating shaft, and the bottom of liner (11) is provided with a driving rod (57) that drives the limit rocker (56) to rotate, so that the elastic annule (553) is less likely to detach from the expansion ring (513), and the limit rocker (56) is provided with a caulking groove (561) for partial insertion of the elastic annule (553);
when the dust collecting bucket (51) is snap-fitted on the liner (11), the driving rod (57) drives the limit rocker (56) to rotate and limit the elastic annule (553) to the expansion ring (513);
when the dust collecting bucket (51) is removed from the liner (11), the limit rocker (56) automatically rotates and resets to detach elastic annule (553) from the caulking groove (561) and make the dust inlet (551) in a closed state.

9. The starting power supply for car battery according to claim 8, wherein the outer peripheral wall of the dust bag (55) is provided with a plurality of dovetail strips (552) spaced apart in the circumferential direction, and the inner peripheral wall of the dust collecting bucket (51) is provided with a plurality of dovetail grooves (512) in which the dovetail strips (552) slides and inserts to limit the dust bag (55);
the opening of the dust bag (55) is provided with a contraction rope (554) to shrink the opening, and the ring protection bracket (54) is provided with a hook (542) to hang the contraction rope (554);
when the dust collecting bucket (51) is removed from the liner (11), the dust bag (55) moves together with the dust collecting bucket (51), and meanwhile the contraction rope (554) helps contract the opening of dust bag (55).

10. The starting power supply for car battery according to claim 4, wherein the vacuumizing module (4) is a blower (6) that is installed inside the liner (11), and the bottom of the housing (1) is provided with an air inlet (61) into which vacuum suction nozzles can be inserted, and an air outlet (62) into which blowing nozzles of different specifications can be inserted.
